(19) United States
(12) Patent Application Publication
(10) Pub. No.: US 2026/0162305 A1
(43) Pub. Date: Jun. 11, 2026

(54) METHOD AND DEVICE FOR DETERMINING A CURRENT CALIBRATION AND/OR CHECKING AN INITIAL CALIBRATION OF A CAMERA SYSTEM OF A MICROSCOPE

(71) Applicant: Carl Zeiss Microscopy GmbH, Jena (DE)

(72) Inventors: Manuel Amthor, Jena (DE); Daniel Haase, Zöllnitz (DE)

(73) Assignee: Carl Zeiss Microscopy GmbH, Jena (DE)

(21) Appl. No.: 19/178,958

(22) Filed: Apr. 15, 2025

(30) Foreign Application Priority Data
Apr. 26, 2024 (DE) 10 2024 111 857.1

(51) Int. Cl. G06T 7/80; G02B 21/36; G06T 7/12; G06T 7/73

(52) U.S. Cl. CPC G06T 7/80; G02B 21/365; G06T 7/12; G06T 7/74; G06T 2207/10056; G06T 2207/20084

(57) ABSTRACT

A computer-implemented method for determining a current calibration and/or checking an initial calibration of a camera system of a microscope is provided, the camera system comprising an overview camera arranged and configured to provide an overview image of a sample carrier situated on a sample stage of the microscope, and a system camera arranged and configured to provide a microscope image of the sample carrier situated on the sample stage. The overview image and the microscope image overlap in an overlap region. The method comprises determining the current calibration and/or checking the initial calibration based on a pose of a predetermined structure of the sample carrier in the overview image and a pose of the predetermined structure in the microscope image.

### CROSS REFERENCE TO RELATED APPLICATION

This application claims priority to German patent application 10 2024 111 857.1 filed on Apr. 26, 2024, which is hereby incorporated by reference in its entirety.

### TECHNICAL FIELD

The present disclosure relates to a computer-implemented method for determining a current calibration and/or checking an initial calibration of a camera system of a microscope. The present disclosure relates to a device for data processing for a camera system of a microscope, which device is configured to carry out the method at least in part. The present disclosure relates to a camera system for a microscope comprising the device for data processing. The present disclosure relates to a computer program comprising instructions which, when the program is executed by the device for data processing, cause this device to carry out the method at least in part. The present disclosure relates to a computer-readable medium comprising instructions which, when the instructions are executed by the device for data processing, cause this device to carry out the method at least in part.

### BACKGROUND

Conventional microscopes comprise a system camera or microscope camera directed at a sample stage. A sample carrier is arrangeable on the sample stage, such that said sample carrier is situated in the field of view of the microscope camera and recordings or microscope images of the sample carrier can be captured by means of said microscope camera.

In cases in which the sample carrier comprises a plurality of sample chambers, for example, it is difficult for a user of the microscope to determine (manually and/or in an automated manner), solely on the basis of the microscope image encompassing only a segment of the sample carrier, which of the sample chambers is imaged in the microscope image.

The prior art therefore discloses, inter alia, microscopes which comprise a so-called (macroscopic) overview camera in addition to a microscope camera or system camera. The overview camera and the microscope camera jointly form a camera system of the microscope.

The overview camera and the microscope camera are coordinated with one another by means of an initial calibration of the camera system, which can be stored in the microscope e.g. at the factory or by the manufacturer of the microscope. In other words, the initial calibration indicates which region of the overview image corresponds to the microscope image. To put it another way, the overview image comprises a segment which can also be seen in the microscope image or of which the microscope image comprises. The initial calibration makes it possible to determine this segment in the overview image. For the initial calibration, accordingly, the relative pose between the overview image recorded by the overview camera and the microscope image recorded by the system camera must be known at least to the extent that conversion between the two image coordinate systems can be affected by means of the initial calibration.

Since it is regularly the case that the entire sample carrier can be seen or is imaged in the overview image and which segment of the overview image is represented in the microscope image is known or determinable on account of the initial calibration, it is possible to determine which of the sample chambers is imaged in the microscope image. This information, i.e. the knowledge of which of the sample chambers is imaged in the microscope image, can in turn be used for sample navigation and/or automation of workflows.

However, the quality of the calibration is of great importance for all sample navigation and workflow automation steps based thereon. It has been found, however, that during ongoing operation of the microscope, the region of the overview image to which the microscope image corresponds may change, such that the initial calibration is no longer (sufficiently) correct. This may be caused, inter alia, by a change in the relative position of the two cameras with respect to one another (e.g. loss of accuracy over time for example owing to drift, or changes or modification of the hardware of the microscope) and/or a change in a dimension of the sample carrier (for example, the height of the sample carrier needs to be known in the case of some microscopes in order to be able to convert between the coordinate systems of the overview image and of the objective). Furthermore, it may be unknown whether the initial calibration is still correct (i.e. the microscope may have an unknown status, e.g. calibrated or not calibrated). A current or actual calibration should then be determined.

One possible procedure for this is described in DE 10 2020 101 191 A1, for example. The latter discloses a method for ascertaining a measurement location of a microscope. The method comprises obtaining an overview image of a sample carrier. The method furthermore comprises determining a homography or calibration that enables the overview image to be perspectively converted into a plan view image. The method furthermore comprises identifying the measurement location, with the aid of the determined calibration, in the overview image or in an output image derived therefrom. In accordance with DE 10 2020 101 191 A1, determining the calibration that enables the overview image to be perspectively converted into a plan view image is affected depending on a height of the sample carrier. In other words, for the method described in DE 10 2020 101 191 A1, it is necessary to know the height of the sample carrier.

Furthermore, DE 10 2018 133 188 A1 discloses a distance determining system for a microscope system for coarse focus setting. The distance determining system comprises a sample stage with a placement surface for receiving a sample carrier, the sample stage being displaceable along at least one direction of extent of a sample plane. The distance determining system furthermore comprises an overview camera with a non-telecentric objective for generating digital images, the overview camera being directed at the sample stage. The distance determining system furthermore comprises an evaluation unit connected to the overview camera. The evaluation unit comprises a storage system for storing at least two digital images of the sample stage recorded by means of the overview camera at different viewing angles. The evaluation unit furthermore comprises a trained machine learning-based system for recognizing corresponding structures of a sample carrier that has been inserted into the sample stage in the two recorded digital images, wherein the trained machine learning-based system comprises a trained reference model which is trainable by a set of annotated training images of sample carriers in such a way, and the trained machine learning-based system is thus adapted in such a way, that in the at least two recorded digital images corresponding structures are assignable to one another. The distance determining system furthermore comprises a distance determining unit adapted for determining the distance between a reference point of the sample carrier and a reference point of the overview camera on the basis of the different viewing angles towards the sample stage and a pixel spacing of the two recorded digital images with respect to one another by means of the assigned corresponding structures contained therein. That is to say that, in accordance with the procedure described in DE 10 2018 133 188 A1, at least two digital images of the sample stage recorded at different viewing angles by means of the overview camera are required.

DE 10 2020 126 549 A1 discloses a microscopy system. The microscopy system comprises an overview camera for recording overview images of a sample location environment and a computing device designed for evaluating the overview images, the computing device having calibration parameters for interpreting image coordinates of the overview images. The computing device is designed to control the overview camera for recording at least two overview images at different sample positions or sample stage positions. The computing device is furthermore designed to calculate a displacement imaging for superimposing the overview images, the overview images being converted to an identical perspective with the aid of the calibration parameters. The computing device is furthermore designed to assess whether the calibration parameters are valid on the basis of a correspondence quality between the superimposed overview images. That is to say that, in accordance with the procedure described in DE 10 2020 126 549 A1, at least two overview images recorded at different sample positions or sample stage positions by means of the overview camera are required.

DE 10 2020 123 562 A1 discloses a microscopy system. The microscopy system comprises an overview camera for recording at least one overview image of a sample environment and a computing device designed for evaluating the at least one overview image, the computing device having calibration parameters used to interpret image coordinates of the at least one overview image. The computing device is designed to ascertain from the at least one overview image geometric information concerning at least one reference structure which is imaged in the overview image and the pose or shape of which in the overview image depends on a pose of at least one microscope component, and by computing the ascertained geometric information with predefined reference data to determine whether a change in the microscope component has occurred which adversely affects a validity of the calibration parameters. In other words, for the procedure described in DE 10 2020 123 562 A1, it is necessary to know a target pose or target shape of a reference structure in the overview image.

### SUMMARY

Provided is a computer-implemented method for determining a current calibration and/or checking an initial calibration of a camera system of a microscope. The camera system includes an overview camera arranged and configured to provide an overview image of a sample carrier situated on a sample stage of the microscope, and a system camera arranged and configured to provide a microscope image of the sample carrier situated on the sample stage, the overview image and the microscope image overlapping in an overlap region. The method comprises determining the current calibration and/or checking the initial calibration on the basis of a pose of a predetermined structure of the sample carrier in the overview image and a pose of the predetermined structure in the microscope image.

Provided is a device for data processing for a camera system of a microscope, the camera system including an overview camera arranged and configured to provide an overview image of a sample carrier situated on a sample stage of the microscope, and a system camera arranged and configured to provide a microscope image of the sample carrier situated on the sample stage, the overview image and the microscope image overlapping in an overlap region. The device for data processing comprises a determination module for determining the current calibration on the basis of a pose of a predetermined structure in the overview image and a pose of the predetermined structure of the sample carrier in the microscope image, and/or a checking module for checking the initial calibration on the basis of the pose of the predetermined structure in the overview image and the pose of the predetermined structure in the microscope image.

Provided is a non-transitory computer-readable medium for a device for data processing of a camera system of a microscope, the camera system including an overview camera arranged and configured to provide an overview image of a sample carrier situated on a sample stage of the microscope, and a system camera arranged and configured to provide a microscope image of the sample carrier situated on the sample stage, the overview image and the microscope image overlapping in an overlap region. The computer-readable medium comprises instructions which, when the instructions are executed by the device for data processing, cause the device to determine the current calibration on the basis of a pose of a predetermined structure of the sample carrier in the overview image and a pose of the predetermined structure in the microscope image, and/or to check the initial calibration on the basis of the pose of the predetermined structure in the overview image and the pose of the predetermined structure in the microscope image.

### BRIEF DESCRIPTION OF THE DRAWINGS

In the drawings:

FIG. 1 is a schematic illustration of an example sample carrier which can be used in the context of the method according to the disclosure;

FIG. 2 is a schematic illustration of an example microscope with a camera system according to the disclosure, which is designed or configured for carrying out the method according to the disclosure;

FIG. 3 is a flow diagram for elucidating an exemplary embodiment of a method according to the disclosure for determining a current calibration and/or checking an initial calibration of the camera system of the microscope from FIG. 2;

FIG. 4 schematically shows an overview image which was created from an image recorded by the camera system from FIG. 2;

FIG. 5 schematically shows a microscope image which was recorded by the camera system from FIG. 2;

FIG. 6 schematically shows a part of the overview image from FIG. 4 which was superimposed with information from the microscope image from FIG. 5; and

FIG. 7 is a further schematic illustration of a microscope with a further camera system according to the disclosure, which is designed or configured for carrying out the method according to the disclosure.

### DETAILED DESCRIPTION

In the following, details are set forth to provide a more thorough explanation of the disclosure. However, it will be apparent to those skilled in the art that these implementations may be practiced without these specific details. In other instances, well-known structures and devices are shown in block diagram form or in a schematic view rather than in detail in order to avoid obscuring the disclosure. In addition, features described hereinafter may be combined with each other, even if described with respect to different figures, unless specifically noted otherwise.

Equivalent or like elements or elements with equivalent or like functionality are denoted in the following description with equivalent or like reference numerals. As the same or functionally equivalent elements are given the equivalent or like reference numbers in the figures, a repeated description for elements provided with the equivalent or like reference numbers may be omitted. Hence, descriptions provided for elements having the equivalent or like reference numbers are mutually exchangeable.

Directional terminology, such as “top,” “bottom,” “below,” “above,” “front,” “behind,” “back,” “leading,” “trailing,” etc., may be used with reference to the orientation of the figures being described. Because parts of the disclosure, described herein, can be positioned in a number of different orientations, the directional terminology is used for purposes of illustration and is in no way limiting. It is to be understood that other implementations may be utilized, and structural or logical changes may be made without departing from the scope defined by the claims. The following detailed description, therefore, is not to be taken in a limiting sense.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

In implementations described herein or shown in the drawings, any direct electrical connection or coupling, e.g., any connection or coupling without additional intervening elements, may also be implemented by an indirect connection or coupling, e.g., a connection or coupling with one or more additional intervening elements, or vice versa, as long as the general purpose of the connection or coupling, for example, to transmit a certain kind of signal or to transmit a certain kind of information, is essentially maintained. Features from different implementations may be combined to form further implementations. For example, variations or modifications described with respect to one of the implementations may also be applicable to other implementations unless noted to the contrary.

The terms “substantially” and “approximately” may be used herein to account for small manufacturing tolerances (e.g., within 5%) that are deemed acceptable in the industry without departing from the aspects of the implementations described herein. For example, a resistor with an approximate resistance value may practically have a resistance within 5% of that approximate resistance value.

In the present disclosure, expressions including ordinal numbers, such as “first”, “second”, and/or the like, may modify various elements. However, such elements are not limited by the above expressions. For example, the above expressions do not limit the sequence and/or importance of the elements. The above expressions are used merely for the purpose of distinguishing an element from the other elements. For example, a first box and a second box indicate different boxes, although both are boxes. For further example, a first element could be termed a second element, and similarly, a second element could also be termed a first element without departing from the scope of the present disclosure.

A computer-implemented method for determining a current calibration and/or checking an initial calibration of a camera system of a microscope is provided.

The camera system comprises an overview camera arranged and configured to provide an overview image of a sample carrier situated on a sample stage of the microscope. The camera system comprises a system camera arranged and configured to provide a microscope image of the sample carrier situated on the sample stage. The overview image and the microscope image overlap in an overlap region.

The method comprises determining the current calibration and/or checking the initial calibration on the basis of a pose of a predetermined structure in the overview image and a pose of the predetermined structure in the microscope image.

The method is a computer-implemented method, i.e. one, a plurality, or all of the steps of the method can be carried out at least in part by a computer or a device for data processing, optionally a control device, configured for controlling operation of the camera system, optionally of the microscope.

A microscope can be understood to mean an apparatus or a device which allows objects to be viewed in (greatly) magnified fashion and/or to be represented as images. This can involve objects or a structure of objects with a size below the resolving power of the human eye.

The overview camera can be arranged on the condenser side, i.e. on the opposite side vis-à-vis the system camera relative to the sample carrier. The overview camera can be arranged on the objective side, i.e. on the same side as the system camera relative to the sample carrier vis-à-vis the system camera. In order to provide the overview image, the overview camera can comprise a telecentric or non-telecentric optical unit. The field of view (FoV) of the overview camera is larger than the field of view of the system camera.

The overview image can be a plan view of the sample carrier. The plan view can be recorded directly by the overview camera, i.e. the overview camera can be arranged such that it views the sample carrier perpendicularly (from above or below). However, the overview camera can also be arranged such that it views the sample carrier at an angle different from 90° or obliquely (from above or below). In the latter case, the plan view can be affected by the image recorded by the overview camera being converted using a known angle at which the overview camera views the sample carrier or a support stage for the sample carrier.

The microscope comprises a support stage for the sample carrier or a sample stage. The sample stage can be static, i.e. non-movable. Alternatively, the sample stage can be movable manually and/or in automated or motorized fashion. It is conceivable for the sample stage to be arranged so as to be movable in one, two, or all three spatial directions.

The system camera (which can also be referred to as microscope camera) can be arranged above or below the sample carrier. The system camera can be configured to record the microscope image using various types of contrast (e.g. widefield, LSM, (lattice) light sheet, lensless, etc.). The system camera can comprise a telecentric or non-telecentric optical unit for recording the microscope image.

A calibration can be understood to mean information indicating a spatial relationship of the overview camera relative to the system camera. Additionally, or alternatively, the calibration can be understood to mean information indicating a spatial relationship of an image plane of the overview camera relative to an image plane of the system camera.

The sample carrier can be a device configured to receive a sample to be examined by means of the microscope. The sample carrier can comprise one or more sample chambers, in each of which a sample to be examined by means of the microscope is arranged or arrangeable. The sample carrier or its sample chamber(s) can comprise an outer wall which allows at least the system camera, optionally also the overview camera, to view the sample when the sample carrier is situated on the sample stage. The sample carrier can be, inter alia, e.g. a microtitre plate or multi-well plate, a (multi-) chamber slide, a Petri dish and also a glass slide. The height of the sample carrier can be known.

The predetermined structure can be a part of the sample carrier which, on account of its shape and pose, is recognizable and localizable by means of machine vision both in the overview image and the microscope image. It is conceivable for the same part of the predetermined structure to be recognized in the overview image and in the microscope image. However, it is also conceivable for different parts of the predetermined structure to be used, wherein a first part of the predetermined structure can be seen in the overview image, a second part of the predetermined structure can be seen in the microscope image, and a spatial relationship or a relative pose of the first and second parts of the structure is known (e.g. stored in the initial calibration) and/or is determinable on the basis of the microscope image and the overview image (e.g. by means of approximation/optimization).

The term “pose” used herein can encompass information about a position and optionally an orientation of the structure in the overview image and/or in the microscope image. The position and optionally the orientation of the structure can be indicated for example in a two-dimensional Cartesian coordinate system having its origin at a predetermined and constant point in the overview image (so-called overview image-fixed coordinate system) and/or in the microscope image (so-called microscope image-fixed coordinate system). In this case, the disclosure is not restricted to a two-dimensional coordinate system, rather three-dimensional or four-dimensional systems can also be used. Furthermore, the disclosure is also not restricted to a Cartesian coordinate system, rather other coordinate systems, such as for example a polar coordinate system, can also be used.

The method described above affords a series of advantages here, which are explained below.

By means of the method, independently of a sample carrier used, the current calibration of the camera system of the microscope can be determined during ongoing operation of the microscope and/or an initial calibration of a camera system of a microscope can be checked during ongoing operation of the microscope.

To put it more precisely, the method does not necessitate prior knowledge of dimensions, such as for example a height, of the sample carrier used. The method is therefore usable independently of the sample carrier used. This is because for determining the current calibration, it is necessary to use exclusively information contained in the microscope image (i.e. the pose of the predetermined structure in the microscope image) and the overview image (i.e. the pose of the predetermined structure in the overview image). That is to say that there is no need to add external or previously known information.

Furthermore, the method can be carried out at any time during ongoing operation of the microscope. In other words, carrying out the method does not necessitate recording more than one overview image and/or more than one microscope image. In other words, for the method it is sufficient to use one overview image, which was recorded from a single angle relative to the sample carrier, and one microscope image, which was likewise recorded from a single angle relative to the sample carrier. Therefore, there is no need for the sample stage to be moved. Besides the time saving associated with this, the method is thus also easily applicable to microscopes with a static or non-movable sample stage.

A further advantage of the method is that no additional hardware need be provided on the microscope.

In summary and in other words: Conventional microscopes can be equipped with overview cameras to enable improved navigation and automation. In order that the data of an overview camera can be optimally utilized, the overview camera can be calibrated in relation to the microscope optical unit or the system camera. A problem here is that such a calibration may be sample- and time-variable, and thus may need to be regularly re-estimated or at least corrected. The solution according to the disclosure makes it possible to estimate or to determine or to correct a calibration between the overview camera and the system camera by comparing the image visible by way of the microscope camera with information from the image of the overview camera (and/or vice versa). Reference points used here are structures of sample carriers (for example the edges of sample chambers of a multi-well plate) which can be seen both in the overview image and in the microscope image.

Possible developments of the method described above are explained in detail below.

The method can comprise determining the pose of the predetermined structure situated in the overlap region in the overview image based on the overview image and determining the pose of the predetermined structure in the microscope image on the basis of the microscope image. The method can comprise determining a projected pose of the predetermined structure in the overview image based on the initial calibration of the camera system and the determined pose of the predetermined structure in the microscope image. Determining the current calibration and/or checking the initial calibration can be affected based on the determined projected pose and the determined pose of the predetermined structure in the overview image. Additionally, or alternatively, the method can comprise determining a further projected pose of the predetermined structure in the microscope image based on the initial calibration of the camera system and the determined pose of the predetermined structure in the overview image. Determining the current calibration and/or checking the initial calibration can be affected on the basis of the determined further projected pose and the determined pose of the predetermined structure in the microscope image.

The projected pose can accordingly be understood to mean a pose of the predetermined structure in the overview image which is calculated based on the initial calibration and the determined pose of the predetermined structure in the microscope image. The further projected pose can be understood to mean a pose of the predetermined structure in the microscope image which is calculated based on the initial calibration and the determined pose of the predetermined structure in the overview image.

With regard to determining the current calibration, the use of the initial calibration affords the advantage that a computing power required for carrying out the method can thus be minimized. In detail, using the initial calibration enables determining the current calibration to be affected by adapting the initial calibration. The method thus already starts with a starting value exhibiting only small, expected deviations with respect to the current calibration, and determines the current calibration on the basis thereof. A complete redetermination of the current calibration therefore does not have to be affected and the current calibration can therefore be determined with a relatively low computational complexity.

The same also applies, mutatis mutandis, to checking the initial calibration. Using the projected pose makes it possible to determine the deviation thereof with respect to the determined pose of the predetermined structure in the overview image. Based on the deviation of these two poses, the initial calibration can be checked without the current calibration having to be determined for this purpose. This, too, affords the advantage that a computing power required for carrying out the method can thus be minimized. This analogously also applies to the use of the further projected pose. Insofar as advantages etc. regarding the projected pose are described herein, they analogously also apply to the further projected pose (except if this is explicitly excluded).

The initial calibration and the current calibration can each comprise a transformation specification which makes it possible to determine the projected pose of the predetermined structure in the overview image based on the pose of said predetermined structure in the microscope image. Additionally, or alternatively, the initial calibration and the current calibration can each comprise a further transformation specification which makes it possible to determine the further projected pose of the predetermined structure in the microscope image based on the pose of said predetermined structure in the overview image.

Insofar as advantages etc. regarding the transformation specification are described herein, they analogously also apply to the further projected transformation specification (except if this is explicitly excluded).

The respective calibration can thus make it possible to convert between a coordinate system of the overview camera (so-called overview image-fixed coordinate system, see above) and a coordinate system of the system camera (so-called microscope image-fixed coordinate system, see above). The two coordinate systems can be for example three-dimensional Cartesian coordinate systems having the axes X, X′, Y, Y′ and Z, Z′. The two coordinate systems can be positionally fixed in relation to the overview camera and respectively the system camera. The respective calibration, for converting between the two coordinate systems, can therefore comprise one or more of the following transformation matrices for describing the following relationships:
(1) 3D translation:

$$[ \begin{matrix}{x}^{′} \\ {y}^{′} \\ {z}^{′} \\ 1\end{matrix} ] = [ \begin{matrix}1 & 0 & 0 & {t}_{x} \\ 0 & 1 & 0 & {t}_{y} \\ 0 & 0 & 1 & {t}_{z} \\ 0 & 0 & 0 & 1\end{matrix} ] \cdot [ \begin{matrix}x \\ y \\ z \\ 1\end{matrix} ]$$

wherein the transformation matrix T (tₓ, t_{y}, t_{z}) indicates a translation by the vector tₓ, t_{y} and t_{z}.
(2) 3D scaling:

$$[ \begin{matrix}{x}^{′} \\ {y}^{′} \\ {z}^{′} \\ 1\end{matrix} ] = [ \begin{matrix}{s}_{x} & 0 & 0 & 0 \\ 0 & {s}_{y} & 0 & 0 \\ 0 & 0 & {s}_{z} & 0 \\ 0 & 0 & 0 & 1\end{matrix} ] \cdot [ \begin{matrix}x \\ y \\ z \\ 1\end{matrix} ]$$

wherein the transformation matrix S (Sₓ, S_{y}, S_{z}) indicates a scaling by the factor Sₓ, S_{y} and S_{z}.
(3) 3D rotation about x-axis:

$$[ \begin{matrix}{x}^{′} \\ {y}^{′} \\ {z}^{′} \\ 1\end{matrix} ] = [ \begin{matrix}1 & 0 & 0 & 0 \\ 0 & cos θ & - sin θ & 0 \\ 0 & sin θ & cos θ & 0 \\ 0 & 0 & 0 & 1\end{matrix} ] \cdot [ \begin{matrix}x \\ y \\ z \\ 1\end{matrix} ]$$

wherein the transformation matrix Rₓ(θ) indicates a rotation by the angle θ about the x-axis.
(4) 3D rotation about y-axis:

$$[ \begin{matrix}{x}^{′} \\ {y}^{′} \\ {z}^{′} \\ 1\end{matrix} ] = [ \begin{matrix}cos θ & 0 & sin θ & 0 \\ 0 & 1 & 0 & 0 \\ - sin θ & 0 & cos θ & 0 \\ 0 & 0 & 0 & 1\end{matrix} ] \cdot [ \begin{matrix}x \\ y \\ z \\ 1\end{matrix} ]$$

wherein the transformation matrix R_{y}(θ) indicates a rotation by the angle θ about the y-axis.
(5) 3D rotation about x-axis:

$$[ \begin{matrix}{x}^{′} \\ {y}^{′} \\ {z}^{′} \\ 1\end{matrix} ] = [ \begin{matrix}cos θ & - sin θ & 0 & 0 \\ sin θ & cos θ & 0 & 0 \\ 0 & 0 & 1 & 0 \\ 0 & 0 & 0 & 1\end{matrix} ] \cdot [ \begin{matrix}x \\ y \\ z \\ 1\end{matrix} ]$$

wherein the transformation matrix R_{z}(θ) indicates a rotation by the angle θ about the z-axis.

The above enumeration of the transformation matrices is not exhaustive, and is merely intended to give an overview of one of a plurality of possible configurations of the respective calibration.

The use of such transformation matrices affords the advantage that for converting between the two image planes in which the two coordinate systems are arranged, it is possible to have recourse to known computation specifications.

The method can comprise determining the overlap region on the basis of the initial calibration.

This affords the advantage that the method is also easily applicable to sample carriers which contain multiple instances of the predetermined structure in the overview image. In the case of multi-well plates as sample carriers, they contain a plurality of sample chambers, the edges of which are suitable as the predetermined structure. In the microscope image, however, it may be that only one of the plurality of sample chambers can be seen, or a plurality of the sample chambers, but not all of the sample chambers. The determination of the overlap region on the basis of the initial calibration makes it possible to establish which sample chamber edge in the overview image corresponds to the sample chamber edge which can be seen in the microscope image. Once this assignment has taken place, the current calibration can then be determined based on the assigned predetermined structures, in this example the sample chamber edges assigned to one another. The same applies to checking the initial calibration.

The method can comprise recognizing the predetermined structure in the overview image and respectively the microscope image by means of an image analysis in which at least one pixel of the overview image and respectively of the microscope image is in each case assigned to the predetermined structure.

In the present case, the image analysis is understood to mean machine-based image analysis in which algorithms or software can recognize the predetermined structure in the respective image as an object and can then assign one or more pixels to this object.

Recognizing the predetermined structure in the overview image can comprise a semantic segmentation of the overview image in which the at least one pixel of the overview image is assigned to the predetermined structure.

Additionally or alternatively, recognizing the structure in the microscope image can comprise at least one of the following:
(1) a semantic segmentation of the microscope image in which the at least one pixel of the microscope image is assigned to the predetermined structure,
(2) generating a density map on the basis of the microscope image, said density map indicating a probability of a presence of the predetermined structure in at least one region of the microscope image, and assigning the at least one pixel of the microscope image to the predetermined structure based on the probability,
(3) edge detection used to detect outer edges of the predetermined structure in the microscope image, and assigning the at least one pixel of the microscope image to the predetermined structure based on the detected outer edges.

The semantic segmentation can involve a so-called deep learning algorithm. In the semantic segmentation, a category or a label can be assigned to each pixel in an image. In the present case it is conceivable, for example, to use two categories, namely foreground and background. All pixels which exhibit the predetermined structure can then be assigned to the foreground by means of the semantic segmentation. The remaining pixels can be assigned to the background. The semantic segmentation affords the advantage that the relevant object (here the predetermined structure) at the pixel level can extend over a plurality of regions in the image. In contrast to object recognition, in which the objects to be recognized may need to fit into a bounding box, even irregularly shaped objects can therefore be properly recognized by the semantic segmentation. The training of a semantic segmentation network for classifying images can comprise the following steps: (1) providing a training data set comprising labelled microscope images and/or overview images, (2) providing a semantic segmentation network, and (3) training the segmentation network for classifying microscope images and/or overview images using the training data set (optional as long as a predetermined accuracy of the segmentation network is attained). The disclosure can also be considered to be directed, on its own and/or in combination with the further aspects described herein, to such training or production of a semantic segmentation network, optionally comprising or consisting of a convolutional neural network.

Edge detection should be differentiated from the semantic segmentation described above. It does also involve a segmentation method, but an edge-oriented method, which should be differentiated from region-oriented segmentation, which is what semantic segmentation is regarded as. An edge can be a boundary between two zones in the respective image, which boundary is inherently homogeneous with regard to a uniformity criterion (also called step edge). The advantage of using (traditional) edge detection is that this does not require training of an algorithm and hence nor does it require a training data set.

The semantic segmentation of the overview image and/or of the microscope image can be affected by means of at least one ML algorithm, optionally an artificial neural network, further optionally a convolutional neural network and/or a transformer.

An ML (machine learning) algorithm can be understood to mean an algorithm which is based on machine learning or was obtained by way of this. In the case of machine learning, an artificial system learns from examples, the so-called training data, and can generalize them after the learning phase has ended. For this purpose, algorithms in the case of machine learning build a statistical model. That is to say that the examples are not simply memorized, rather patterns and regularities in the learning data are recognized. In this regard, after training the system can also assess unknown data (so-called learning transfer).

An artificial neural network (for short: ANN) can be understood to mean a statistical model. ANNs are machine learning models. An ANN is based on a plurality of interconnected units or nodes, referred to as artificial neurons. Each connection can forward a signal to other neurons. An artificial neuron receives signals, processes them and can pass signals to the neurons connected to it. The “signal” at a connection is a real number, and the output of each neuron is calculated by a non-linear function of the sum of its inputs. The connections are referred to as edges. Neurons and edges generally have a weight that adjusts during the learning process. The weighting increases or decreases the strength of the signal at a connection. Neurons may have a threshold value such that a signal is sent only if the overall signal exceeds this threshold value. Neurons can be combined in layers. Different layers can perform different transformations on their inputs. The signals travel from the first layer (the input layer) to the last layer (the output layer), possibly after they have traversed the layers a number of times. An ANN is generally referred to as a deep neural network if it comprises at least two hidden layers.

A convolutional neural network (CNN) should be understood as a special ANN. CNNs have three main types of layers: (1) convolutional layer, (2) pooling layer, and (3) fully connected (FC) layer. The convolutional layer is the first layer of a convolutional network. While convolutional layers may be followed by further convolutional layers or pooling layers, the fully connected layer is the last layer. The complexity of the CNN increases with each layer, such that larger and larger parts of an image are recognized. Earlier layers concentrate on simple features, such as colours and edges. When the image data traverse the layers of the CNN, the latter begins to recognize larger elements or shapes of the object, until it finally identifies the desired object.

A (vision) transformer for semantic segmentation can be understood to mean an algorithm comprising an encoder and a decoder. The algorithm can be configured to divide an input image into a plurality of patches and to input the patches into the encoder. The encoder can be configured to determine and output features for each of the patches. The decoder can be configured to obtain learnable query tokens as input, each query corresponding to an object category, such as e.g. foreground or sample chamber edge and background. The decoder can be configured to output embeddings of the queries. The algorithm can be configured to generate segmentation results by multiplying the features output by the encoder and the embeddings of the queries output by the decoder.

The density map can indicate, for each location or each pixel of the microscope image, a respective probability of whether (or not) the predetermined structure is situated there. By contrast, a segmentation indicates a binary value as to whether the predetermined structure is situated there. One advantage of the density map may be that the latter comprises continuous (probability) values and an optimization or registration can become stabler or more accurate as a result. Moreover, a continuous prediction can be trainable with less complexity than a segmentation model.

It is conceivable that determining the pose of the predetermined structure in the overview image comprises determining coordinates of the at least one pixel of the overview image which is assigned to the predetermined structure in an overview image-fixed coordinate system. It is conceivable that determining the pose of the predetermined structure in the microscope image comprises determining coordinates of the at least one pixel of the microscope image which is assigned to the predetermined structure in a microscope image-fixed coordinate system.

The transformation specification comprising the initial calibration can make it possible to determine the projected pose of the predetermined structure in the overview image on the basis of the pose of said predetermined structure in the microscope image by transforming the coordinates of the at least one pixel of the microscope image which is assigned to the predetermined structure from the microscope image-fixed coordinate system into the overview image-fixed coordinate system. Determining the projected pose of the predetermined structure in the overview image can comprise transforming the coordinates of the at least one pixel of the microscope image which is assigned to the predetermined structure from the microscope image-fixed coordinate system into the overview image-fixed coordinate system by means of the transformation specification of the initial calibration.

The further transformation specification comprising the initial calibration can make it possible to determine the further projected pose of the predetermined structure in the microscope image on the basis of the pose of said predetermined structure in the overview image by transforming the coordinates of the at least one pixel of the overview image which is assigned to the predetermined structure from the overview image-fixed coordinate system into the microscope image-fixed coordinate system. Determining the further projected pose of the predetermined structure in the microscope image can comprise transforming the coordinates of the at least one pixel of the overview image which is assigned to the predetermined structure from the overview image-fixed coordinate system into the microscope image-fixed coordinate system by means of the further transformation specification of the initial calibration.

In other words, the localization of the predetermined structure in the overview image can be affected by means of an image analysis, optionally on the basis of machine learning (e.g. deep neural networks such as CNNs or transformers). This can be implemented for example by a semantic segmentation in which pixel masks can be generated, in which each pixel is assigned a class (e.g. sample carrier, sample chamber, sample chamber edge). Furthermore, a detection can be provided which involves determining coordinates of the sample chambers (e.g. centre point, enclosing coordinates, etc.) and/or the sample carrier edges (optionally rasterized or for each pixel). Furthermore, it is possible to provide a so-called instance segmentation, which constitutes a mixture of the abovementioned segmentation and detection. In this case, pixel masks, as in the case of the semantic segmentation described above, can be generated separately for each sample chamber, the separation being predefined by a detection. The segmentation and the detection can proceed in parallel here in a single model. Post-processing of the results can optionally be performed. In the case of a segmentation, the pixel masks can be post-processed by filtering and “smoothing”. This can be done by employing conditional random fields (CRFs), which refine or correct the decision for each pixel in the result image based on the neighbouring pixels. In the case of a detection, uncertain detections and detections found multiple times can be filtered (e.g. with the aid of a non-maximum suppression). Since sample carriers (optionally multi-well plates) usually have a regular arrangement of sample chambers in a repeating pattern, it is possible to allow this context knowledge also to influence the overall result. For this purpose, e.g. in the case of a segmentation of the sample chambers, it is possible to use a parametrized model of the sample chamber geometry and arrangement, wherein the parameters can be determined by optimization on the basis of the segmentation masks.

The localization of the sample chamber edges in the microscope image can also be accomplished by means of image analysis, optionally on the basis of machine learning (e.g. deep neural networks such as CNNs or transformers), such that the above description concerning the overview image also applies, mutatis mutandis, to the microscope image (and vice versa). The instance segmentation described above is advantageous if a plurality of the predetermined structures are visible in the field of view of the objective of the system camera or in the microscope image. The use of a density map (e.g. by means of image-to-image mapping) indicating the probability of the presence of a sample carrier edge is also conceivable. Traditional image processing is furthermore conceivable (e.g. finding a sample chamber edge by means of traditional edge detection).

The method can comprise determining a relative pose of the determined projected pose with respect to the determined pose of the predetermined structure in the overview image, wherein determining the current calibration and/or checking the initial calibration are/is affected based on the determined relative pose.

Additionally, or alternatively, the method can comprise determining a further relative pose of the determined further projected pose with respect to the determined pose of the predetermined structure in the microscope image, wherein determining the current calibration and/or checking the initial calibration are/is affected based on the determined further relative pose.

That is to say that it is possible to affect an assignment of the pose of the predetermined structure, e.g. of corresponding edge regions of sample chambers, between microscope image and overview image. As starting position, for this purpose it is possible to calculate the target position or projected pose using the initial calibration or basic calibration (and optionally a height estimation of the sample carrier) from one image into the respective other image. It is thus possible to determine the target position of the image segment of the microscope image in the overview image. Parameters for a recalibration or correction parameters for an existing calibration can be derived from the assignment of the pose of corresponding predetermined structures. This can involve for example at least one of the following items of information: status of the initial calibration (e.g. deviation too large or no corresponding structures found), current calibration parameters, a height estimation of the current sample carrier, homography parameters, index of an existing calibration to be selected as the current calibration, intrinsic parameters (e.g. distortion) of the overview camera and/or extrinsic parameters (e.g. relative pose, rotation, scaling in space) of the overview camera in relation to the system camera. These items of information can in turn be used for example as follows in subsequent steps: assessing the current calibration, carrying out a recalibration, updating the existing or initial calibration and/or selecting a calibration from a list of existing calibrations as the current calibration.

Determining the relative pose can comprise determining a difference between the coordinates of the projected pose of the predetermined structure in the overview image and the coordinates of the pose of the predetermined structure in the overview image.

Additionally, or alternatively, determining the further relative pose can comprise determining a difference between the coordinates of the further projected pose of the predetermined structure in the microscope image and the coordinates of the pose of the predetermined structure in the microscope image.

In other words, the relative pose or the difference in pose between target (projected pose) and actual (actual pose in the overview image) can be calculated by way of a calculation of the deviation of the difference between the coordinates of the projected pose and the actual pose.

Determining the current calibration can comprise adapting the initial calibration on the basis of the determined difference (between the coordinates of the projected pose of the predetermined structure in the overview image and the coordinates of the pose of the predetermined structure in the overview image) and/or the further difference (between the coordinates of the projected pose of the predetermined structure in the microscope image and the coordinates of the pose of the predetermined structure in the microscope image).

Additionally, or alternatively, checking the initial calibration can comprise comparing the determined difference and/or the further difference with a (respective) predetermined limit value.

It is conceivable for adapting the initial calibration to be affected such that the difference between the coordinates is minimized if this difference is determined with the adapted initial calibration in the manner described above. The minimizing can be affected iteratively, for example. The method can be ended as soon as the difference falls below the predetermined limit value. The minimizing can be affected by determining the difference with a plurality of initial calibrations. That calibration from among the plurality of calibrations (stored in the microscope) for which the difference is minimal can be set or adopted as the current calibration.

Determining the relative pose can comprise determining an initial size of an overlapping region in the overview image in which the predetermined structure is arranged in accordance with the determined projected pose and the determined pose of the predetermined structure in the overview image.

Additionally, or alternatively, determining the further relative pose can comprise determining an initial size of an overlapping region in the microscope image in which the predetermined structure is arranged in accordance with the determined further projected pose and the determined pose of the predetermined structure in the microscope image.

Determining the current calibration can comprise adapting the initial calibration based on the determined initial size of the overlapping region in the overview image and/or the microscope image to obtain the current calibration. The adapting can be affected such that a size of the overlapping region determined based on the current calibration which was obtained by the adapting is large in comparison with the initial size of the overlapping region. Checking the initial calibration can comprise comparing the determined initial size of the overlapping region in the overview image and/or the microscope image with a (respective) predetermined limit value.

In other words, the intersection over union (IoU) method can be employed to determine the relative pose. For the assignment of the pose of the predetermined structure between microscope image and overview image, an optimization (with known degrees of freedom) can be affected. Maximizing the IoU or the overlapping region can be affected by optimizing the calibration on the basis of which the projected pose and thus in turn the relative pose, here the overlapping region, are determined. The optimization method can be any desired optimization method (e.g. traditional optimization by means of least squares, Newton, gradient descent, etc.). An optimization of the correspondence of the density maps (e.g. by means of correlation) can be performed. A correspondence between density maps and segmentation masks can be used. An optimization of point correspondence algorithms (e.g. RANSAC, ICP, 8-Point Alg., etc.) can be performed. In other words, it is possible to ascertain a displacement vector between the predetermined structure contained in the two images. Since both images originate from different recording modalities, said vector cannot be ascertained by means of simple registration (e.g. cross-correlation). Therefore, both images can be converted into an image space indicating whether or not the predetermined structure is situated at a pixel position. This image space can be discrete, as in the case of the segmentation, or continuous, as in the case of the density map. The image space can be “dense”, as in the case of the segmentation, or “sparse”, as in the case of the detection. If both images have been converted into the image space, the displacement vector can be determined by optimization. This can be done, if the image space is “dense” (see above), by the images being correlated. Furthermore, this can be done by applying a point correspondence algorithm if the image space is “dense” (see above). The result may be the displacement vector that causes the least “error” between the images.

It is conceivable for adapting the initial calibration to be affected such that the overlapping region is maximized if the latter is determined with the adapted initial calibration in the manner described above. The maximizing can be affected iteratively, for example. The method can be ended as soon as the overlapping region exceeds the predetermined limit value. The maximizing can be affected by determining the overlapping region with a plurality of initial calibrations. That calibration from among the plurality of calibrations (stored in the microscope) for which the overlapping region is maximal can be set or adopted as the current calibration.

Determining the relative pose and/or the further relative pose can comprise inputting the overview image and the microscope image into an ML algorithm configured to determine the relative pose and/or the further relative pose, optionally as scalar, on the basis of the input overview image and the input microscope image. Determining the relative pose and/or the further relative pose can be affected by means of the ML algorithm on the basis of the input overview image and the input microscope image.

Additionally, or alternatively, it is accordingly possible to use an ML model which obtains both image segments as (concatenated) input and outputs the deviation as scalar/vector. One advantage of this is that manual intermediate steps of segmentation and/or detection and optimization are not required, rather the displacement vector can be learned from data. Analogously to the method described above, the displacement vector ascertained by means of the ML model can be used as correction for checking the initial calibration and/or for determining the current calibration.

The method can comprise recording a first image by means of the overview camera, based on which first image the overview image is determined or which first image constitutes the overview image. Additionally, or alternatively, the method can comprise recording a second image by means of the system camera, based on which second image the microscope image is determined or which second image constitutes the microscope image.

The recording of the overview image and/or of the microscope image can be initiated in a dedicated manner, e.g. in the context of a workflow for setting up the microscope or in the context of a calibration workflow. Additionally or alternatively, the recording of the overview image can be initiated during ongoing operation of the microscope, e.g. while a user is working on the microscope or in the context of an ongoing experiment.

It is conceivable for the overview image and the microscope image to be recorded at the same point in time.

It is conceivable for the recording of the overview image and/or of the microscope image to be initiated manually by a user input and/or in an automated manner by means of the camera system itself.

The predetermined structure can be an upper and/or a lower edge of a sample chamber of the sample carrier.

Two scenarios can be differentiated here, in principle. In the first scenario, the overview camera and the system camera view the same side or surface of the sample carrier. In this case, the predetermined structure chosen can be either the upper edge, if the two cameras are situated above the sample carrier, or the lower edge of the sample carrier, if the two cameras are situated below the sample carrier. The method can then make use of the fact that the upper or the lower edge is arranged in a global coordinate system at a specific pose in space, such that the current calibration can be determined as a result. In the second scenario, the two cameras are situated on opposite sides of the sample carrier, such that exclusively the upper edge can be seen in one of the images and exclusively the lower edge of the sample carrier chamber can be seen in the other of the images. However, it is also possible for both edges to be at least partly visible in the respective images if the sample carrier is transparent.

The method can comprise determining, based on the determined current calibration, that sample chamber which is situated in a field of view of the system camera.

It is conceivable for a control signal to be output to an information output unit of the microscope, which unit outputs to the user of the microscope information concerning that sample chamber which is situated in the field of view of the system camera in accordance with the determined current calibration.

Furthermore, the disclosure relates to a device for data processing for a camera system of a microscope.

The camera system comprises an overview camera arranged and configured to provide an overview image of a sample carrier situated on a sample stage of the microscope. The camera system comprises a system camera arranged and configured to provide a microscope image of the sample carrier situated on the sample stage. The overview image and the microscope image overlap in an overlap region.

The device for data processing is configured to determine the current calibration based on a pose of a predetermined structure in the overview image and a pose of the predetermined structure of the sample carrier in the microscope image. Additionally, or alternatively, the device for data processing is configured to check the initial calibration based on the pose of the predetermined structure in the overview image and the pose of the predetermined structure in the microscope image.

The device for data processing can be a computer, which optionally can serve as a control unit or control device for the microscope or the camera system and can be configured to control operation of the microscope or of the camera system. The device for data processing can be arranged at least partly in or on the microscope or the camera system. The device for data processing can be arranged at least partly remotely from the microscope or the camera system. The remotely arranged parts of the device for data processing can be connected to the microscope or the camera system in a wired and/or wireless manner for the purpose of data exchange.

The device for data processing can be configured to carry out the above-described method at least in part.

What has been described above regarding the method applies, mutatis mutandis, to the device for data processing, and vice versa.

Furthermore, the disclosure relates to a camera system for a microscope, wherein the camera system comprises the above-described device for data processing.

The camera system can have or comprise an overview camera arranged and configured to provide an overview image of a sample carrier situated on a sample stage of the microscope, and a system camera arranged and configured to provide a microscope image of the sample carrier situated on the sample stage, the overview image and the microscope image overlapping in an overlap region.

It is conceivable for a microscope comprising the camera system described above to be provided.

What has been described above regarding the method and to the device for data processing applies, mutatis mutandis, to the camera system, and vice versa.

Furthermore, the disclosure relates to a computer program for a device for data processing of a camera system of a microscope.

The camera system comprises an overview camera arranged and configured to provide an overview image of a sample carrier situated on a sample stage of the microscope, and a system camera arranged and configured to provide a microscope image of the sample carrier situated on the sample stage, the overview image and the microscope image overlapping in an overlap region.

The computer program comprises instructions which, when the program is executed by the device for data processing, cause this device to determine the current calibration on the basis of a pose of a predetermined structure of the sample carrier in the overview image and a pose of the predetermined structure in the microscope image, and/or to check the initial calibration on the basis of the pose of the predetermined structure in the overview image and the pose of the predetermined structure in the microscope image.

A program code of the computer program can be present in any desired code, optionally in a code suitable for controllers of a microscope or a camera system of a microscope.

What has been described above regarding the method, to the device for data processing and to the camera system applies, mutatis mutandis, to the computer program, and vice versa.

Furthermore, the disclosure relates to a computer-readable medium for a device for data processing of a camera system of a microscope.

The camera system comprises an overview camera arranged and configured to provide an overview image of a sample carrier situated on a sample stage of the microscope, and a system camera arranged and configured to provide a microscope image of the sample carrier situated on the sample stage, the overview image and the microscope image overlapping in an overlap region.

The computer-readable medium comprises instructions which, when the instructions are executed by the device for data processing, cause this device to determine the current calibration on the basis of a pose of a predetermined structure of the sample carrier in the overview image and a pose of the predetermined structure in the microscope image, and/or to check the initial calibration on the basis of the pose of the predetermined structure in the overview image and the pose of the predetermined structure in the microscope image.

That is to say that a computer-readable medium comprising a computer program defined above can be provided.

The computer-readable medium can be any desired digital data storage apparatus, such as for example a USB stick, a hard disk, a CD-ROM, an SD card or an SSD card (or SSD drive/SSD hard disk).

The computer program need not necessarily be stored on such a computer-readable storage medium to be made available to the microscope, but rather can also be obtained externally via the Internet or in some other way.

In other words, the computer-readable medium can be a data signal which comprises instructions which, when the instructions are executed by the device for data processing, cause this device to determine the current calibration on the basis of a pose of a predetermined structure of the sample carrier in the overview image and a pose of the predetermined structure in the microscope image, and/or to check the initial calibration on the basis of the pose of the predetermined structure in the overview image and the pose of the predetermined structure in the microscope image.

Identical and identically acting parts are identified by the same reference signs in the FIGS.

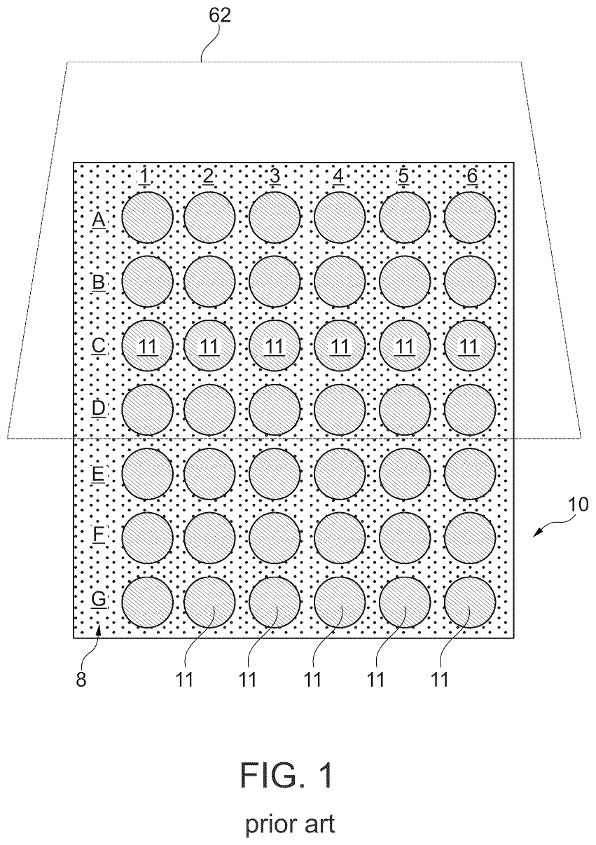

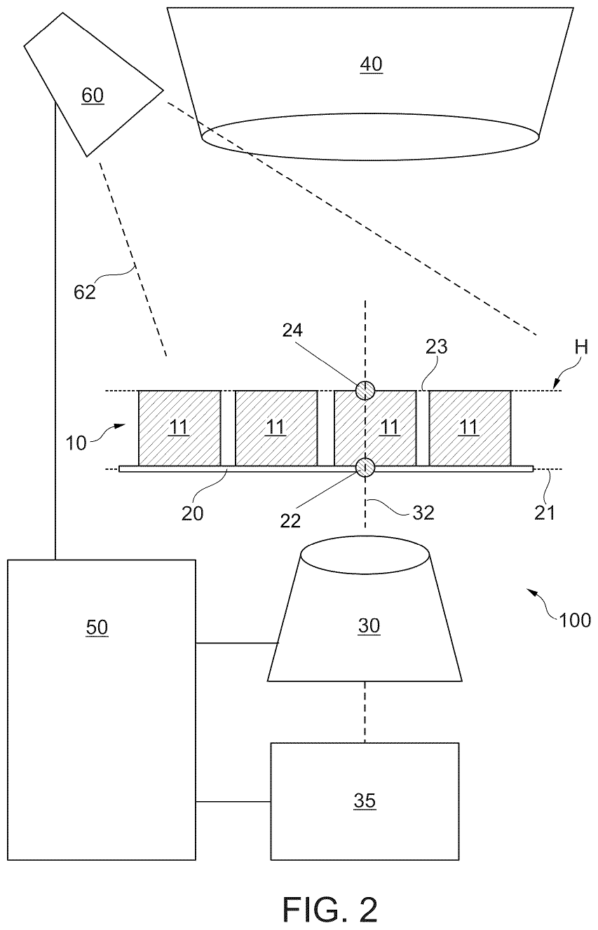

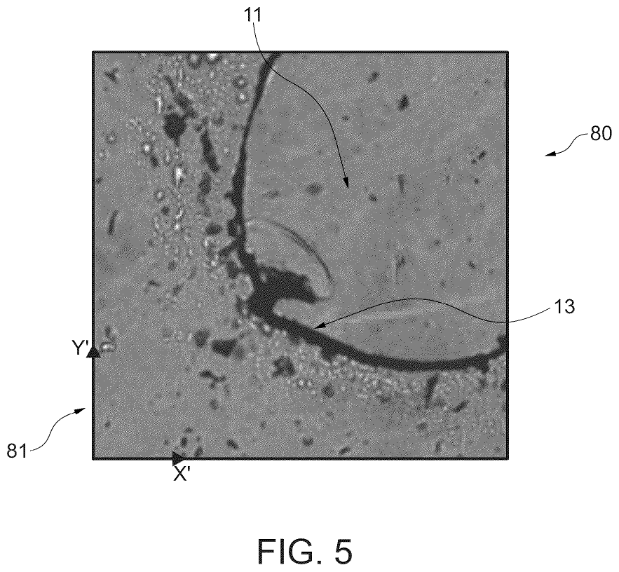

FIG. 1 schematically shows a sample carrier 10 with a plurality of sample vessels or sample carrier chambers 11. The illustrated example involves a microtitre plate or a multi-well plate with a plurality of sample carrier chambers (wells) 11. The sample carrier chambers 11 are arranged in columns and rows, wherein a row label 8 indicates the various rows A-G and a column label indicates columns 1-6. In the context of a predefined or predefinable workflow, the sample carrier chambers 11 can be examined using a microscope 100 illustrated in FIG. 2, wherein said microscope records one or more microscope images of each of said chambers (see FIG. 5).

The microscope 100 illustrated in FIG. 2 comprises an overview camera 60 arranged and configured to provide an overview image of the sample carrier 10 situated on a sample stage 20 of the microscope 100, and a system camera 35 with an objective 30, said system camera being arranged and configured to provide a microscope image 80 of the sample carrier 10 situated on the sample stage 20. The field of view 62 of the overview camera 60, in FIGS. 1 and 2, is depicted with dashed lines in FIG. 2 and covers a part of the sample carrier 10 in the present case. The overview image 70 and the microscope image 80 overlap in an overlap region 71 along the optical axis 32 of the system camera 35 and the objective 30 thereof, the measurement location of the system camera 35 simultaneously lying in said overlap region.

The sample carrier 10 comprises the plurality of sample carrier chambers 11, in at least some of which samples to be examined are situated. Illumination light is guided to the sample carrier 10 via a condenser 40. Detection light emanating from the samples can be detected via an objective 30 with the system camera 35.

In the illustrated example, the overview camera 60 is situated on an opposite side of the sample carrier 10 relative to the objective 30. As a result, the overview camera 60 records an overview image of an upper side 23 of the sample carrier 10. A plane of the upper side 23 perpendicular to the optical axis 32 indicates the height H of the sample carrier 20. The measurement location 22 is generally offset along the optical axis 32 with respect to the upper side 23 recorded in the overview image 70. Depending on the microscope setting, the measurement location 22 is located in the region of a lower side 21 of the sample carrier 10 or at a distance from the upper side 23 in any case. Therefore, a point of intersection 24, which corresponds to the projection of the measurement location 22 on the upper side 23 along the optical axis 32, should be ascertained in the overview image. The pose of this point of intersection 24 in the overview image indicates the lateral pose of the measurement location 22.

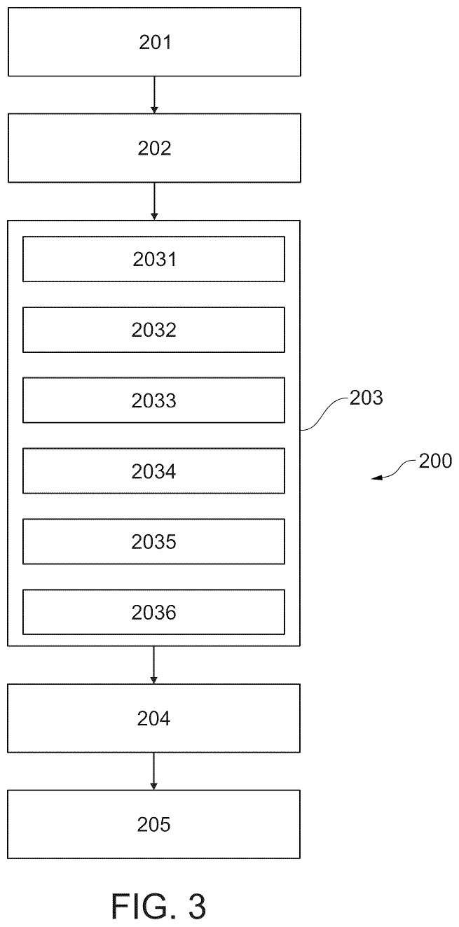

A difficulty results from the fact that the height dimension of the sample carrier 10, and hence the pose of the upper side 23, is unknown or variable. In the overview image 70, the pose of the point of intersection 24 fluctuates depending on the distance between the upper side 23 and the overview camera 60 and thus depending on the height H. The disclosure provides a solution allowing the lateral pose of the measurement location 22 to be deduced from the overview image and the microscope image. For this purpose, a computing device or device for data processing 50 evaluates a recorded overview image 70 and a recorded microscope image 80 in accordance with the method according to the disclosure for determining a current calibration and/or checking an initial calibration, the flow diagram of which method is illustrated in FIG. 3. As indicated in FIG. 2, the device for data processing 50 is also designed for control and (data-technological) communication with various components of the microscope 100, here inter alia with the overview camera 60 and the system camera 35.

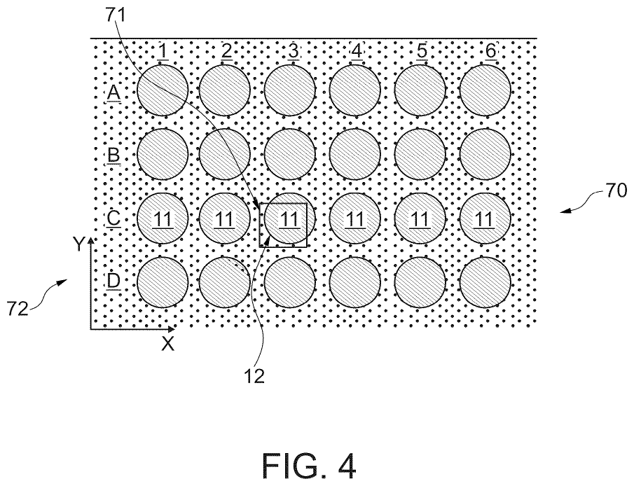

In a first step 201 of the method 200, the device for data processing 50 controls the overview camera 60 such that the latter records a first image of the sample carrier. In the present case, the recorded image does not constitute a plan view, since the overview camera 60 views the sample carrier 10 obliquely. Therefore, in the first step 201, the device for data processing 50 converts the image recorded by the overview camera 60 into a plan view corresponding to the overview image 70 illustrated in FIG. 4. The overview image 70 reveals or depicts the rows A-G of the sample carrier 10 in accordance with the field of view 62 of the overview camera 60 shown in FIG. 1.

In a second step 202 of the method 200, the device for data processing 50 controls the system camera 35 such that the latter likewise records an image of the sample carrier 10. The image recorded by the system camera 35 from the measurement location 22 is a plan view and can therefore be used directly as the microscope image 80 illustrated in FIG. 5.

The first and second steps 201, 202 can be carried out temporally simultaneously or at the same time, at least in part.

In a third step 203 of the method, the device for data processing 50 carries out an image analysis. By means of the image analysis, this involves recognizing in each case a predetermined structure, here an edge 12, 13 of one of the sample chambers 11, in the overview image 70 and the microscope image 80, wherein at least one pixel of the overview image 70 and respectively of the microscope image 80 is in each case assigned to the edge 12, 13. This involves the upper edge 12 of the sample chamber 11 in the case of the overview image 70, and the lower edge 13 of the same sample chamber 11 in the case of the microscope image 80.

In detail, in a first sub-step 2031 of the third step 203, the device for data processing 50 determines the overlap region 71 of the field of view of the overview camera 60 and the system camera 35 in the overview image 70 based on the initial calibration (i.e. the calibration stored in the camera system at this point in time). In other words, the initial calibration is taken as a basis for determining where the measurement location 22 of the system camera 35 is situated in the overview image 70 in accordance with the initial calibration.

The actual image analysis of the overview image 70, more precisely of the overlap region 71 ascertained in the first sub-step 2031 of the third step 203, is affected in a second sub-step 2032 of the third step 203. Recognizing the predetermined structure in the overlap region 71 is affected by means of a semantic segmentation of the overlap region 71 of the overview image 70 which is carried out by the device for data processing 50 and in which each pixel of the overlap region 71 is assigned to either the background or the foreground, i.e. the upper edge 12 of the sample chamber 11 situated in the overlap region 71.

The actual image analysis of the microscope image 80, i.e. recognizing the lower edge 13 of the sample chamber 11 in the microscope image 80, is affected in a third sub-step 2033 of the third step 203. This can be affected by means of a semantic segmentation of the microscope image 80 in which each pixel of the microscope image 80 is assigned to either the background or the foreground, i.e. the lower edge 13 of the sample chamber 11 situated in the overlap region 71. Additionally, or alternatively, recognizing the lower edge 13 can be affected by means of generating a density map based on the microscope image 80, said density map indicating a probability of a presence of the lower edge 13 in a region of the microscope image 80, and assigning pixels of the microscope image 80 to the lower edge 13 on the basis of the probability. Additionally, or alternatively, recognizing the lower edge 13 can be affected by means of (traditional) edge detection, by means of which outer edges of the lower edge 13 are detected in the microscope image 80, and the pixels of the microscope image 80 which lie within a region delimited by the detected outer edges are assigned to the lower edge 13.

The semantic segmentation both of the overview image 70 (see second sub-step 2032 of the third step 203) and of the microscope image 80 (third sub-step 2033 of the third step 203) is affected by means of an ML algorithm (optionally comprising or consisting of an artificial neural network, further optionally a convolutional neural network and/or a transformer). For this purpose, the overview image 70 is input into a first appropriately trained ML algorithm, which yields as the result at least one pixel mask in which the respective pixels corresponding to the upper edge 13 are identified as assigned to the foreground. Analogously thereto, the microscope image 80 is input into a second appropriately trained ML algorithm, which yields as the result likewise at least one pixel mask in which the respective pixels corresponding to the lower edge 13 are identified as assigned to the foreground.

The second and third sub-steps 2032, 2033 can be carried out temporally simultaneously, at least in part.

In a fourth sub-step 2034 of the third step 203, the device for data processing 50 determines the pose of the upper edge 12 in the overview image 70, said upper edge being situated in the overlap region 71 and having been recognized by means of the image analysis (see above), based on the overview image 70. In other words, the coordinates of the pixels of the overview image 70 which have been assigned to the upper edge 12 (see above) are determined. These coordinates are determined in an overview image-fixed two-dimensional coordinate system 72, having the axes X and Y, wherein the axes X and Y lie in the image plane of the overview image 70, i.e. in the present case in the plane of the upper side 23 of the sample carrier 10.

In a fifth sub-step 2035 of the third step 203, the device for data processing 50 determines the pose of the lower edge 12 in the microscope image 80, said lower edge having been recognized by means of the image analysis (see above), based on the microscope image 80. In other words, the coordinates of the pixels of the overview image 70 which have been assigned to the lower edge 13 (see above) are determined. These coordinates are determined in a microscope image-fixed two-dimensional coordinate system 81, having the axes X′ and Y′, wherein the axes X′ and Y′ lie in the image plane of the microscope image 80, i.e. in the present case in the plane of the lower side 21 of the sample carrier 10.

The fourth and fifth sub-steps 2034, 2035 can be carried out temporally simultaneously, at least in part.

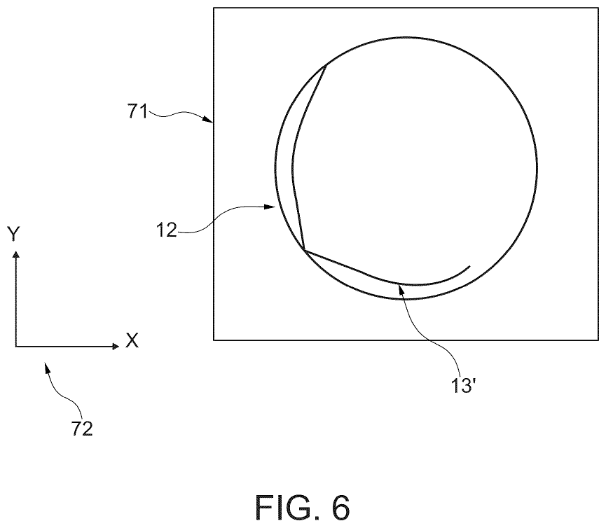

In a sixth sub-step 2036 of the third step 203, the device for data processing 50 determines a projected pose of the lower edge 13 in the overview image 70 based on the initial calibration of the camera system and the determined pose of the lower edge 13 in the microscope image 80. For this purpose, the initial calibration comprises a (n initial) transformation specification which makes it possible to determine the projected pose of the lower edge in the overview image 70 based on the pose thereof in the microscope image 80. In other words, the coordinates of the pixels which are assigned to the lower edge 13 in the microscope image 80 are converted or transformed from the microscope image-fixed coordinate system 81 into the overview image-fixed coordinate system 72 by means of the initial calibration. The result of this transformation is clarified pictorially in FIG. 6, wherein FIG. 6 illustrates the overlap region 71 from the overview image 70 superimposed with the course or the projected pose 13′ of the lower edge 13. It is also conceivable to determine a projected pose of the upper edge 12 in the microscope image 80 on the basis of the initial calibration of the camera system and the determined pose of the upper edge 12 in the overview image 70. The description of the embodiment is analogously applicable to this case.

A fourth step 204 of the method 200 then involves determining the current calibration and/or checking the initial calibration based on the determined projected pose 13′ of the lower edge 13 and the determined pose of the upper edge 12 in the overview image 70. This is done by determining a relative pose of the determined projected pose 13′ of the lower edge 13 with respect to the determined pose of the upper edge 12 in the overview image, wherein determining the current calibration and/or checking the initial calibration are/is affected based on the determined relative pose.

In the simplest case of a lateral displacement of the projected pose 13′ with respect to the pose of the upper edge 12 in the overview image, determining the relative pose can be affected by determining a difference in the overview image-fixed coordinate system 72 between the coordinates of the projected pose 13′ and the coordinates of the pose of the predetermined structure in the overview image. The difference thus determined can firstly be used to adapt the initial calibration in order to obtain the current calibration, or in order to check the initial calibration for the validity or correctness thereof, for example by comparing the difference with a predetermined limit value.

In more complex cases it may be necessary to employ the IoU method. Determining the relative pose can comprise for this purpose determining an initial size of an overlapping region of the projected pose 13′ with the upper edge 12 in the overview image. In other words, the overlapping region is the region in which there is overlap of the lower edge 13 in accordance with the determined projected pose 13′ and the determined pose of the predetermined structure 12 in the overview image. Checking the correctness of the initial calibration can involve checking whether the overlapping region is large enough. If this is the case, then the initial calibration can be assumed to be correct. For adapting or correcting the initial calibration, it is conceivable to maximize the overlapping region between the two regions 12, 13′, e.g. iteratively, by laterally displacing the projected pose 13′ of the lower edge 13 in the overview image. If the overlapping region obtained is large enough, e.g. larger than a correspondingly predetermined limit value, the current calibration can be ascertained based on the position of the projected pose 13 at this point in time.

It is also conceivable for determining the relative pose to comprise inputting the overview image and the microscope image into an ML algorithm configured to determine the relative pose, optionally as scalar or vector, on the basis of the input overview image and the input microscope image, and for determining the relative pose to be affected by means of the ML algorithm on the basis of the input overview image and the input microscope image.

In other words, instead of (or in addition to) segmentation of both images 70, 80 and ascertaining the displacement vector by optimization or correlation, this vector can be obtained by inputting both images 70, 80 into an ML model, which thereupon outputs the displacement vector. For this purpose, the ML model can have been trained with data for which the displacement vector is known. These data can be generated e.g. by simulation and thus without manual annotation complexity.

Therefore, a computer-implemented method for producing or training an ML model can also be provided according to the disclosure. The method can comprise providing training data. The training data can comprise a plurality of training examples, each training example comprising in each case a microscope image 80, an overview image 70 and an associated displacement vector. The method can comprise training (e.g. supervised learning) of the ML model, the ML model being configured, after training, to predict a displacement vector for a microscope image 80 not contained in the training data and for an associated overview image 70 not contained in the training data, optionally with a predetermined quality. It is conceivable for the training data to be obtained by means of a computer-aided simulation. The displacement vector can be used for checking the initial calibration and/or for determining the current calibration.

Since the lateral offset, above as relative pose of the determined projected pose 13′ of the lower edge 13 with respect to the determined pose of the upper edge 12 in the overview image, depends on the height H of the sample carrier 10, the method accordingly makes it possible to determine the height H of the sample carrier 10 currently being used. Therefore, in the present case, the initial calibration and the current calibration each indicate a transformation specification which makes it possible to determine the projected pose 13′ of the lower edge 13 in the overview image 70 based on its pose of the lower edge 13 in the microscope image 80.

A fifth step 205 of the method can involve determining, based on the determined current calibration, that sample chamber 11 which is situated in a field of view of the system camera 35.

The present disclosure is not restricted to a microscope 100 in which the two cameras 30, 35, 60 are arranged in opposite places with respect to the sample carrier 10.

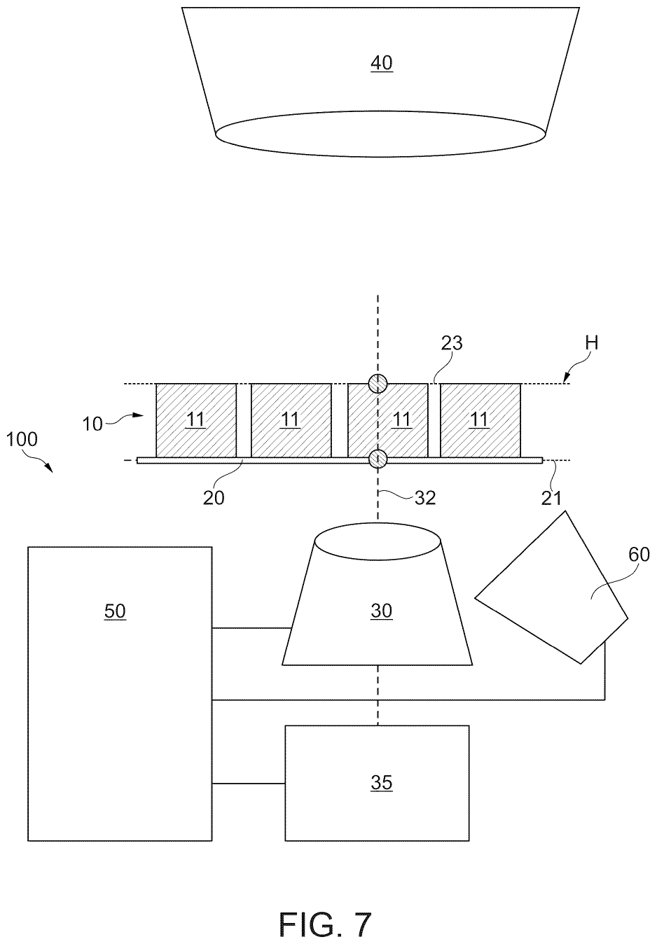

In accordance with a further exemplary embodiment, it is also conceivable for the two cameras 30, 60 to be arranged on the same side of the sample carrier 10, as is illustrated in FIG. 7. The above description of FIGS. 1 to 6 is analogously applicable to this exemplary embodiment as well, and only the differences with respect to the above exemplary embodiment are described below.

The microscope 100 comprises a motorized sample stage 20, on which the sample carrier 10 is arranged. Both cameras 35, 60 are arranged below the sample stage 20. The overview camera 60 can be a non-telecentric camera. The relative pose of the objective 30 of the system camera 35 with respect to the overview camera 60 can be constant or substantially unchangeable. As described above, an initial or current calibration of the microscope 100 exists.

The method described above with reference to FIGS. 2 to 6 can now be used for the microscope 100 illustrated in FIG. 7, too, in order, on the basis of the overview image 70 recorded by the overview camera 60, to determine whether the initial calibration is (still) valid and, if this is not the case, to determine a currently valid calibration by correcting the initial calibration. However, since the overview camera 60 and the system camera 35 both view the sample carrier 10 or the sample plane from the same side, here from below, the perspective challenges described above with reference to FIG. 2 do not occur.

In the first step 201, as described above, the overview image 70 is recorded by the overview camera 60. The third step 203 is carried out. The determination of the overlap region 71 in accordance with the first sub-step 2031 of the third step 203 can be omitted under certain circumstances, but can also be carried out. The third step 203 involves, as described above (see sub-steps 2032 and 2034 of the third step 203), recognizing the lower edge(s) 13 of the sample chamber(s) in the overview image 70 (optionally only the edge(s) 13 situated in the overlap region) based on the overview image 70, and determining the pose thereof therein. On the basis of this determined pose and a position—assumed therefor—of the system camera 35 relative to the sample stage 20, using the initial calibration, an expected or projected pose of the lower edge(s) 13 of the sample chamber(s) in the microscope image 80 is determined (in this respect, see sub-step 2036 of the third step 203). This assumed position is moved to, insofar as necessary, by means of the motorized sample stage 20 and the microscope image 80 is then recorded, as described above in the second step 202. As described above in respect of the sub-steps 2033, 2035 of the third step 203, the procedure involves recognizing the lower edge(s) 13 of the sample chamber(s) in the microscope image 80 (optionally only the edge(s) 13 situated in the overlap region) based on the microscope image 80, and determining the pose thereof therein. Analogously to the procedure described above regarding the sub-step 2036, the projected pose of the edge(s) 13 is then compared with the actual pose thereof in the microscope image 80. Based on a result of this comparison, the initial calibration is corrected, insofar as necessary, in order to obtain the current calibration (in this respect, see also step 204).

### REFERENCE SYMBOLS

1-7 columns
8 rows
10 sample carrier
11 sample chamber
12 upper edge of the sample chamber
13 lower edge of the sample chamber
13′ projected pose of the lower edge of the sample chamber in the overview image
20 sample stage
21 lower side of the sample carrier
22 measurement location
23 upper side of the sample carrier
24 point of intersection
30 objective of the system camera
35 system camera
32 optical axis of the system camera
40 condenser
50 device for data processing
60 overview camera
62 field of view of the overview camera
70 overview image
71 overlap region
72 overview image-fixed coordinate system
80 microscope image
81 microscope image-fixed coordinate system
100 microscope
200 method
201-205 method steps
X, Y axes of the overview image-fixed coordinate system
X′, Y′ axes of the microscope image-fixed coordinate system

What is claimed is:

1. A computer-implemented method for determining a current calibration and/or checking an initial calibration of a camera system of a microscope, the camera system including an overview camera arranged and configured to provide an overview image of a sample carrier situated on a sample stage of the microscope, and a system camera arranged and configured to provide a microscope image of the sample carrier situated on the sample stage, the overview image and the microscope image overlapping in an overlap region, wherein the method comprises determining the current calibration and/or checking the initial calibration based on a pose of a predetermined structure of the sample carrier in the overview image and a pose of the predetermined structure in the microscope image.

2. The computer-implemented method according to claim 1, wherein the method further comprises:
determining the pose of the predetermined structure situated in the overlap region in the overview image based on the overview image,
determining the pose of the predetermined structure in the microscope image based on the microscope image, and
determining a projected pose of the predetermined structure in the overview image based on the initial calibration of the camera system and the determined pose of the predetermined structure in the microscope image and/or a further projected pose of the predetermined structure in the microscope image based on the initial calibration of the camera system and the determined pose of the predetermined structure in the overview image,
wherein determining the current calibration and/or checking the initial calibration are/is affected based on the determined projected pose in the overview image and the determined pose of the predetermined structure in the overview image and/or are/is affected based on the determined further projected pose in the microscope image and the determined pose of the predetermined structure in the microscope image.

3. The computer-implemented method according to claim 2, wherein:
the initial calibration and the current calibration each include a transformation specification which makes it possible to determine the projected pose of the predetermined structure in the overview image based on the pose of said predetermined structure in the microscope image, and/or
the initial calibration and the current calibration each include a further transformation specification which makes it possible to determine the further projected pose of the predetermined structure in the microscope image based on the pose of said predetermined structure in the overview image.

4. The computer-implemented method according to claim 2, wherein the method comprises determining the overlap region based on the initial calibration.

5. The computer-implemented method according to claim 1, wherein the method comprises recognizing the predetermined structure in the overview image and respectively the microscope image by means of an image analysis in which at least one pixel of the overview image and respectively of the microscope image is in each case assigned to the predetermined structure.

6. The computer-implemented method according to claim 5, wherein:
recognizing the predetermined structure in the overview image includes a semantic segmentation of the overview image in which the at least one pixel of the overview image is assigned to the predetermined structure, and/or
recognizing the structure in the microscope image includes:
a semantic segmentation of the microscope image in which the at least one pixel of the microscope image is assigned to the predetermined structure,
generating a density map based on the microscope image, said density map indicating a probability of a presence of the predetermined structure in at least one region of the microscope image, and assigning the at least one pixel of the microscope image to the predetermined structure based on the probability, and/or
edge detection used to detect outer edges of the predetermined structure in the microscope image, and assigning the at least one pixel of the microscope image to the predetermined structure based on the detected outer edges.

7. The computer-implemented method according to claim 6, wherein the semantic segmentation of the overview image and/or of the microscope image is affected by means of at least one ML algorithm, optionally an artificial neural network, further optionally a convolutional neural network and/or a transformer-based network.

8. The computer-implemented method according to claim 6, wherein the method further comprises:
determining the pose of the predetermined structure situated in the overlap region in the overview image based on the overview image,
determining the pose of the predetermined structure in the microscope image based on the microscope image, and
determining a projected pose of the predetermined structure in the overview image based on the initial calibration of the camera system and the determined pose of the predetermined structure in the microscope image and/or a further projected pose of the predetermined structure in the microscope image based on the initial calibration of the camera system and the determined pose of the predetermined structure in the overview image,
wherein determining the current calibration and/or checking the initial calibration are/is affected based on the determined projected pose in the overview image and the determined pose of the predetermined structure in the overview image and/or are/is affected based on the determined further projected pose in the microscope image and the determined pose of the predetermined structure in the microscope image,
wherein determining the pose of the predetermined structure in the overview image includes determining coordinates of the at least one pixel of the overview image which is assigned to the predetermined structure in an overview image-fixed coordinate system,
wherein determining the pose of the predetermined structure in the microscope image includes determining coordinates of the at least one pixel of the microscope image which is assigned to the predetermined structure in a microscope image-fixed coordinate system,
wherein a transformation specification including the initial calibration makes it possible to determine the projected pose of the predetermined structure in the overview image based on the pose of said predetermined structure in the microscope image by transforming the coordinates of the at least one pixel of the microscope image which is assigned to the predetermined structure from the microscope image-fixed coordinate system into the overview image-fixed coordinate system, and
wherein determining the projected pose of the predetermined structure in the overview image comprises transforming the coordinates of the at least one pixel of the microscope image which is assigned to the predetermined structure from the microscope image-fixed coordinate system into the overview image-fixed coordinate system by use of the transformation specification of the initial calibration.

9. The computer-implemented method according to claim 6, wherein the method further comprises:
determining the pose of the predetermined structure situated in the overlap region in the overview image based on the overview image,
determining the pose of the predetermined structure in the microscope image based on the microscope image, and
determining a projected pose of the predetermined structure in the overview image based on the initial calibration of the camera system and the determined pose of the predetermined structure in the microscope image and/or a further projected pose of the predetermined structure in the microscope image based on the initial calibration of the camera system and the determined pose of the predetermined structure in the overview image,
wherein determining the current calibration and/or checking the initial calibration are/is affected based on the determined projected pose in the overview image and the determined pose of the predetermined structure in the overview image and/or are/is affected based on the determined further projected pose in the microscope image and the determined pose of the predetermined structure in the microscope image,
wherein determining the pose of the predetermined structure in the overview image includes determining coordinates of the at least one pixel of the overview image which is assigned to the predetermined structure in an overview image-fixed coordinate system,
wherein determining the pose of the predetermined structure in the microscope image includes determining coordinates of the at least one pixel of the microscope image which is assigned to the predetermined structure in a microscope image-fixed coordinate system,
wherein a further transformation specification including the initial calibration makes it possible to determine the further projected pose of the predetermined structure in the microscope image based on the pose of said predetermined structure in the overview image by transforming the coordinates of the at least one pixel of the overview image which is assigned to the predetermined structure from the overview image-fixed coordinate system into the microscope image-fixed coordinate system, and
wherein determining the further projected pose of the predetermined structure in the microscope image comprises transforming the coordinates of the at least one pixel of the overview image which is assigned to the predetermined structure from the overview image-fixed coordinate system into the microscope image-fixed coordinate system by use of the further transformation specification of the initial calibration.

10. The computer-implemented method according to claim 2, wherein the method comprises:
determining a relative pose of the determined projected pose with respect to the determined pose of the predetermined structure in the overview image, wherein determining the current calibration and/or checking the initial calibration are/is affected based on the determined relative pose, and/or
determining a further relative pose of the determined further projected pose with respect to the determined pose of the predetermined structure in the microscope image, wherein determining the current calibration and/or checking the initial calibration are/is affected based on the determined further relative pose.

11. The computer-implemented method according to claim 10, wherein:
determining the relative pose includes determining a difference between coordinates of the projected pose of the predetermined structure in the overview image and the coordinates of the pose of the predetermined structure in the overview image, and/or
determining the further relative pose includes determining a further difference between the coordinates of the further projected pose of the predetermined structure in the microscope image and the coordinates of the pose of the predetermined structure in the microscope image.

12. The computer-implemented method according to claim 11, wherein:
determining the current calibration includes adapting the initial calibration based on the determined difference and/or further difference, and/or
checking the initial calibration includes comparing the determined difference and/or the further difference with a predetermined limit value.

13. The computer-implemented method according to claim 10 wherein:
determining the relative pose includes determining an initial size of an overlapping region in the overview image in which the predetermined structure is arranged in accordance with the determined projected pose and the determined pose of the predetermined structure in the overview image, and/or
determining the further relative pose includes determining an initial size of an overlapping region in the microscope image in which the predetermined structure is arranged in accordance with the determined further projected pose and the determined pose of the predetermined structure in the microscope image.

14. The computer-implemented method according to claim 13, wherein:
determining the current calibration includes adapting the initial calibration based on the determined initial size of the overlapping region in the overview image and/or the microscope image in order to obtain the current calibration, wherein the adapting is affected such that a size of the overlapping region determined based on the current calibration which was obtained by the adapting is large in comparison with the initial size of the overlapping region, and/or
checking the initial calibration includes comparing the determined initial size of the overlapping region in the overview image and/or the microscope image with a predetermined limit value.

15. The computer-implemented method according to claim 10, wherein:
determining the relative pose and/or the further relative pose includes inputting the overview image and the microscope image into an ML algorithm configured to determine the relative pose and/or the further relative pose, optionally as scalar, based on the input overview image and the input microscope image, and
determining the relative pose and/or the further relative pose is affected by use of the ML algorithm based on the input overview image and the input microscope image.

16. The computer-implemented method according to claim 1, wherein the method further comprises:
recording a first image by means of the overview camera, based on which first image the overview image is determined or which first image constitutes the overview image, and/or
recording a second image by means of the system camera, on basis of which second image the microscope image is determined or which second image constitutes the microscope image.

17. The computer-implemented method according to claim 1, wherein the predetermined structure is an upper and/or a lower edge of a sample chamber of the sample carrier.

18. The computer-implemented method according to claim 1, wherein the method comprises determining, based on the determined current calibration, that sample chamber which is situated in a field of view of the system camera.

19. A device for data processing for a camera system of a microscope, the camera system including an overview camera arranged and configured to provide an overview image of a sample carrier situated on a sample stage of the microscope, and a system camera arranged and configured to provide a microscope image of the sample carrier situated on the sample stage, the overview image and the microscope image overlapping in an overlap region, wherein the device for data processing comprises a controller programmed to:
determine a current calibration based on a pose of a predetermined structure in the overview image and a pose of the predetermined structure of the sample carrier in the microscope image, and/or
check an initial calibration based on the pose of the predetermined structure in the overview image and the pose of the predetermined structure in the microscope image.

20. A non-transitory computer-readable medium for a device for data processing of a camera system of a microscope, the camera system including an overview camera arranged and configured to provide an overview image of a sample carrier situated on a sample stage of the microscope, and a system camera arranged and configured to provide a microscope image of the sample carrier situated on the sample stage, the overview image and the microscope image overlapping in an overlap region, wherein the computer-readable medium comprises instructions which, when the instructions are executed by the device for data processing, cause the device:
to determine a current calibration based on a pose of a predetermined structure of the sample carrier in the overview image and a pose of the predetermined structure in the microscope image, and/or
to check an initial calibration based on the pose of the predetermined structure in the overview image and the pose of the predetermined structure in the microscope image.
